(19) United States
(12) Patent Application Publication
(10) Pub. No.: US 2022/0384987 A1
(43) Pub. Date: Dec. 1, 2022

(54) CONNECTOR

(71) Applicant: SUMITOMO WIRING SYSTEMS, LTD., Mie (JP)

(72) Inventor: Naoki HIKOTA, Mie (JP)

(21) Appl. No.: 17/745,644

(22) Filed: May 16, 2022

(30) Foreign Application Priority Data
May 28, 2021 (JP) 2021-089904

(51) Int. Cl. H01R 13/52; H01R 13/629; H01R 13/11

(52) U.S. Cl. CPC H01R 13/5202; H01R 13/62933; H01R 13/11

(57) ABSTRACT

A connector is provided with a sealing member to be sandwiched between a first housing and a second housing. The sealing member includes a sealing hole penetrating through a sealing body portion in a front-rear direction and a positioning recess formed in a front surface of the sealing body portion. The second housing includes a pre-fitting member and a post-fitting member separate from the pre-fitting member. The pre-fitting member includes a pre-fitting body portion to be arranged in front of the sealing body portion and a positioning projection projecting from a rear surface of the pre-fitting body portion and to be fit into the positioning recess. The post-fitting member includes a peripheral wall portion to be held in contact with an outer peripheral surface of the sealing member.

### CROSS-REFERENCE TO RELATED APPLICATIONS

This application is based on and claims priority from Japanese Patent Application No. 2021-089904, filed on May 28, 2021, with the Japan Patent Office, the disclosure of which is incorporated herein in its entirety by reference.

### TECHNICAL FIELD

The present disclosure relates to a connector.

### BACKGROUND

A connector described in Japanese Patent Laid-open Publication No. 2014-220058 includes a housing, a rear holder and a sealing member (one-piece rubber plug) arranged between the housing and the rear holder. The sealing member is formed with a plurality of sealing holes penetrating in a front-rear direction. Positioning recesses are formed in the front surface of the sealing member. Positioning pins are formed to project on the rear surface of the housing. A peripheral wall portion is formed to project rearward on the outer peripheral edge of the housing.

The sealing member is inserted into the inside of the peripheral wall portion and positioned in the housing by fitting the positioning pins into the positioning recesses. The peripheral wall portion is held in close contact with a lip formed on the outer periphery of the sealing member. A connector provided with such a sealing member and a housing is also disclosed in Japanese Patent Laid-open Publication Nos. 2003-151678 and 2002-075523.

### SUMMARY

In Japanese Patent Laid-open Publication No. 2014-220058, when the positioning pins are inserted into the positioning recesses, the sealing member may be pressed by the peripheral wall portion and compressively deformed radially inwardly. Since a relative positional relationship of the positioning pins and the positioning recesses deviates if the sealing member is compressively deformed, such a trouble that the positioning pins cannot be properly inserted into the positioning recesses occurs.

Accordingly, the present disclosure aims to provide a connector capable of improving the positioning accuracy of a sealing member.

The present disclosure is directed to a connector with a first housing, a second housing, and a sealing member to be arranged between the first housing and the second housing, wherein the sealing member includes a sealing body portion, a sealing hole penetrating through the sealing body portion in a front-rear direction and a positioning recess formed in a front surface of the sealing body portion, the second housing includes a pre-fitting member and a post-fitting member separate from the pre-fitting member, the pre-fitting member includes a pre-fitting body portion to be arranged in front of the sealing body portion and a positioning projection projecting from a rear surface of the pre-fitting body portion and to be fit into the positioning recess, and the post-fitting member includes a peripheral wall portion to be held in contact with an outer peripheral surface of the sealing member.

According to the present disclosure, it is possible to provide a connector capable of improving the positioning accuracy of a sealing member.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector of a first embodiment.

FIG. 2 is an exploded perspective view of a first housing, a pre-fitting member and a post-fitting member.

FIG. 3 is a section of the connector cut at the position of positioning recesses.

FIG. 4 is a section of the connector cut at the position of sealing holes.

FIG. 5 is a front view of the first housing.

FIG. 6 is a plan view of the first housing assembled with the sealing member and the pre-fitting member.

FIG. 7 is a front view of the sealing member.

FIG. 8 is a front view of the pre-fitting member.

FIG. 9 is a back view of the pre-fitting member.

FIG. 10 is a back view of the post-fitting member.

FIG. 11 is a view corresponding to FIG. 1 in a second embodiment.

FIG. 12 is a view corresponding to FIG. 2.

FIG. 13 is a view corresponding to FIG. 3.

FIG. 14 is a view corresponding to FIG. 4.

FIG. 15 is a view corresponding to FIG. 9.

FIG. 16 is a view corresponding to FIG. 10.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

First, embodiments of the present disclosure are listed and described.

(1) The connector of the present disclosure is provided with a first housing, a second housing, and a sealing member to be arranged between the first housing and the second housing, wherein the sealing member includes a sealing body portion, a sealing hole penetrating through the sealing body portion in a front-rear direction and a positioning recess formed in a front surface of the sealing body portion, the second housing includes a pre-fitting member and a post-fitting member separate from the pre-fitting member, the pre-fitting member includes a pre-fitting body portion to be arranged in front of the sealing body portion and a positioning projection projecting from a rear surface of the pre-fitting body portion and to be fit into the positioning recess, and the post-fitting member includes a peripheral wall portion to be held in contact with an outer peripheral surface of the sealing member.

According to the above configuration, after the pre-fitting member is arranged on the front surface side of the sealing member and the positioning projection is fit into the positioning recess, the post-fitting member is assembled and the peripheral wall portion can contact the outer peripheral surface of the sealing member. When the sealing member is pressed by the peripheral wall portion and a radially inward compressive force is applied to the sealing member, the positioning projection is already inserted in the positioning recess. Thus, it is possible to avoid such a trouble that the positioning projection cannot be inserted into the positioning recess.

(2) Preferably, the post-fitting member includes a post-fitting body portion to be arranged in front of the pre-fitting body portion and the peripheral wall portion projects rearward from the post-fitting body portion.

According to the above configuration, forward escape of the pre-fitting member is hindered by the post-fitting body portion.

(3) The pre-fitting body portion may be in the form of a plate having a thickness in the front-rear direction, and the post-fitting body portion may include a cavity for accommodating a terminal fitting and a locking lance projecting inside the cavity to lock the terminal fitting and be formed longer in the front-rear direction than the pre-fitting body portion.

According to the above configuration, the post-fitting member can be formed without largely changing an existing housing and, in addition, the pre-fitting member can be formed compact.

(4) The post-fitting body portion may be in the form of a plate having a thickness in the front-rear direction, and the pre-fitting body portion may include a cavity for accommodating a terminal fitting and a locking lance projecting inside the cavity to lock the terminal fitting and be formed longer in the front-rear direction than the post-fitting body portion.

According to the above configuration, the locking lance of the pre-fitting body portion is protected by the post-fitting body portion and the interference thereof with an external matter can be avoided. Since the post-fitting body portion can also have a function as a front holder, a dedicated front holder can be omitted.

(5) The second housing may include an outer wall portion for covering the first housing, and the outer wall portion may be formed with a window portion for enabling a boundary between a front surface of the sealing body portion and a rear surface of the pre-fitting body portion to be visually confirmed.

According to the above configuration, since the boundary between the front surface of the sealing body portion and the rear surface of the pre-fitting body portion can be visually confirmed through the window portion before the post-fitting member is assembled, it is possible to confirm whether or not a relative positional relationship of the sealing member and the pre-fitting member is proper. As a result, it is possible to confirm whether or not the positioning projection is properly inserted in the positioning recess.

(6) A lever may be rotatably supported on the outer wall portion, the lever may be formed with a cam groove and the cam groove may be engaged with a cam follower of a mating housing, and the window portion may be open on a front end of the outer wall portion and in the form of a groove for receiving the cam follower.

According to the above configuration, since the window portion also has a function of receiving the cam follower, the configuration does not become complicated due to the presence of the window portion.

(7) Either one of the pre-fitting member and the post-fitting member may be formed with an alignment projection projecting toward the other, and the other may be formed with an alignment recess to be fit to the alignment projection.

According to the above configuration, the pre-fitting member and the post-fitting member can be positioned by inserting the alignment projection into the alignment recess.

### DETAILS OF EMBODIMENTS OF PRESENT DISCLOSURE

Specific examples of embodiments of the present disclosure are described below with reference to the drawings. Note that the present invention is not limited to this illustration and is intended to be represented by claims and include all changes in the scope of claims and in the meaning and scope of equivalents.

### First Embodiment

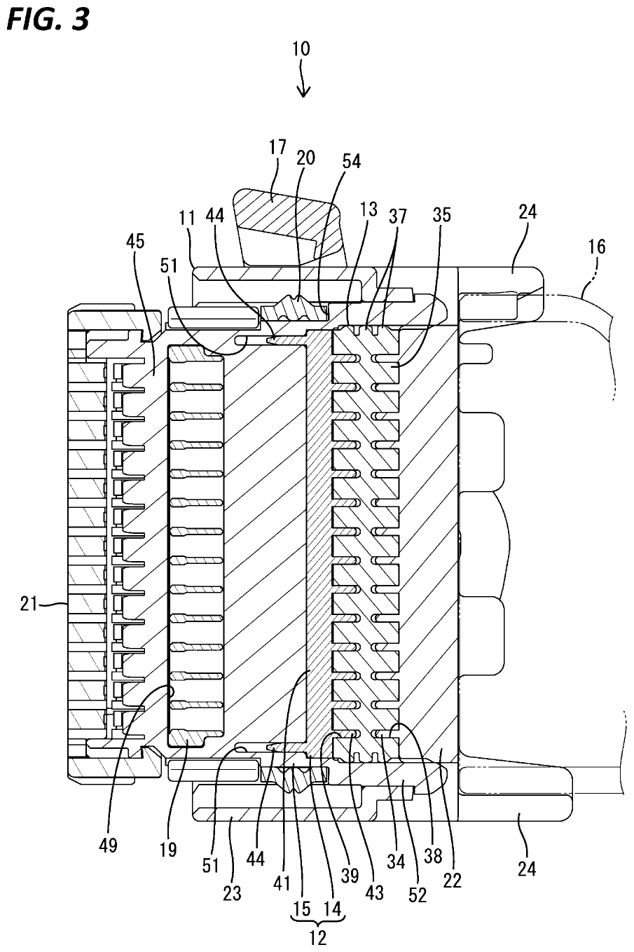

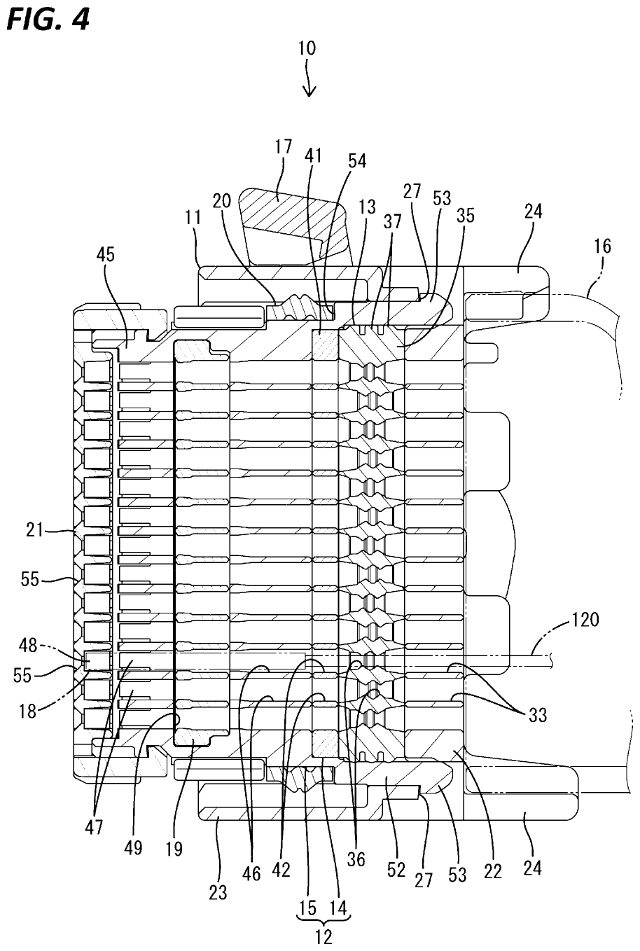

A connector 10 according to a first embodiment includes, as shown in FIGS. 3 and 4, a first housing 11, a second housing 12 and a sealing member 13 to be arranged between the first housing 11 and the second housing 12. The second housing 12 includes a pre-fitting member 14 and a post-fitting member 15, which are separate from each other. Further, the connector 10 includes a wire cover 16, a lever 17, terminal fittings 18, a retainer 19, a rubber ring 20 and a front holder 21.

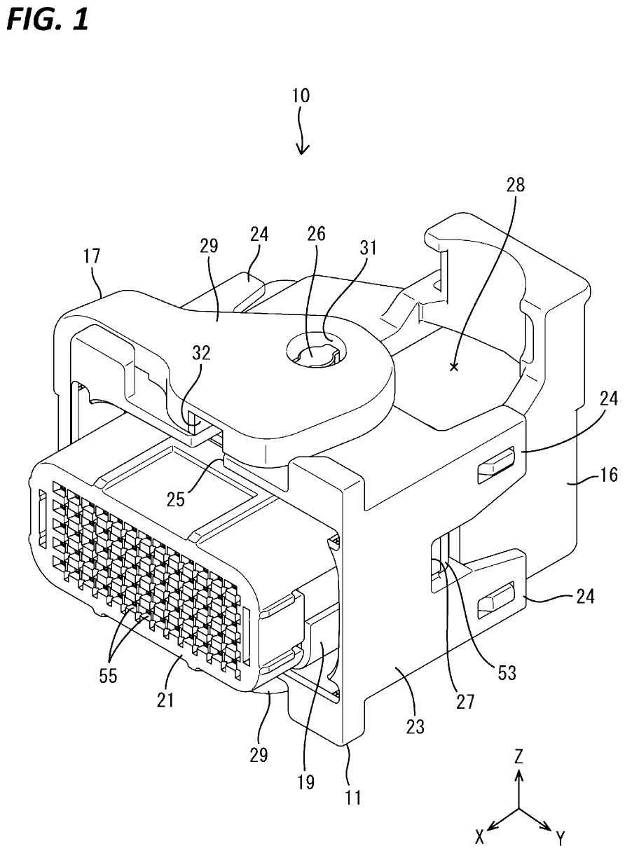

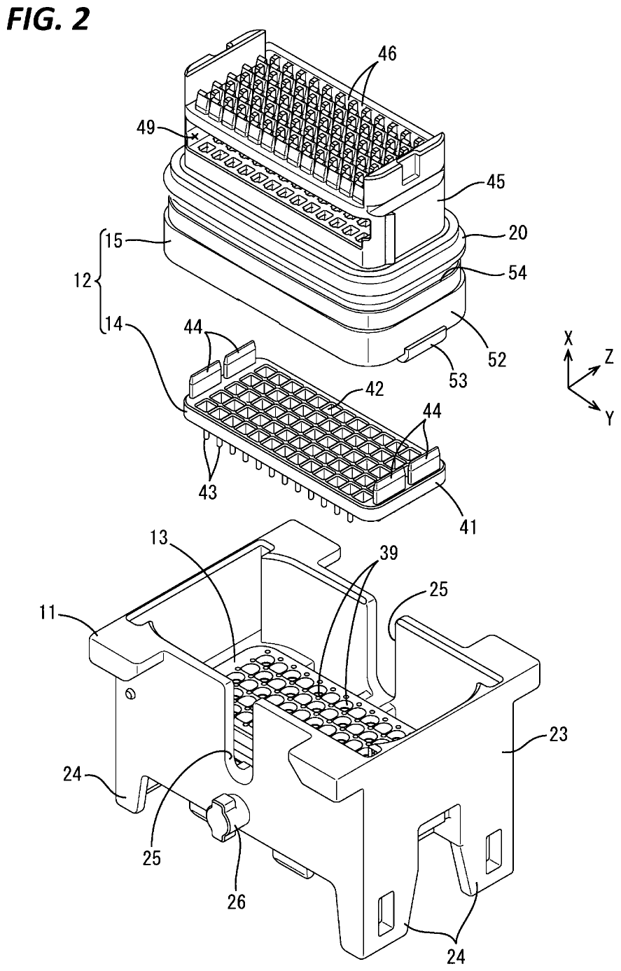

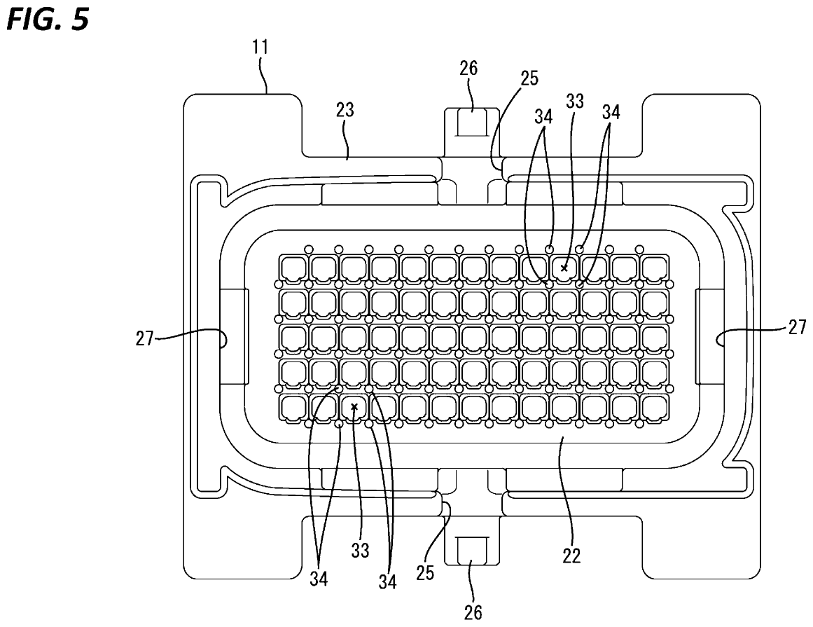

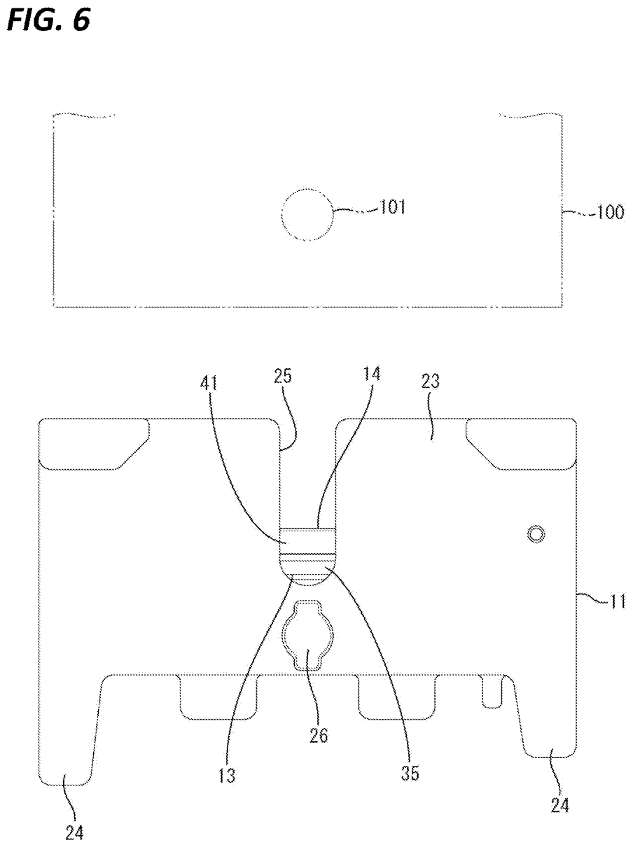

Note that, in the following description, a side where the front holder 21 is located in the connector 10 is referred to as a front side concerning a front-rear direction. An upper side of FIG. 2 is the front side. The sealing member 13, the pre-fitting member 14 and the post-fitting member 15 are successively mounted into the first housing 11 from front. The front side is also a side facing a mating housing 100 when the connector 10 is connected to the mating housing 100 shown in FIG. 6. A vertical direction is based on a vertical direction of FIGS. 5 and 7 to 10. The vertical direction is synonymous with a height direction. A lateral direction is based on a lateral direction of FIGS. 5 to 10. The lateral direction is synonymous with a width direction. In FIGS. 1 and 2, a forward direction is indicated by an arrow X, a rightward direction is indicated by an arrow Y and an upward direction is indicated by an arrow Z.

The first housing 11 is made of synthetic resin and, as shown in FIG. 2, in the form of a rectangular tube. The first housing 11 includes a rear wall portion 22, an outer wall portion 23 and a plurality of cover lock portions 24. The rear wall portion 22 is in the form of a plate and has a thickness in the front-rear direction as shown in FIGS. 3 and 4.

The outer wall portion 23 is in the form of a rectangular tube and projects forward from the outer periphery of the rear wall portion 22. As shown in FIG. 5, the outer wall portion 23 is formed with a pair of upper and lower window portions 25. As shown in FIGS. 2 and 6, the window portion 25 is in the form of a groove, extends in the front-rear direction and is open on the front end of the outer wall portion 23. A pair of upper and lower support shafts 26 are formed to project at positions behind the window portions 25 on the outer surface of the outer wall portion 23. As shown in FIG. 5, a pair of left and right lock receiving portions 27 are formed to penetrate through a rear end part of the outer wall portion 23.

As shown in FIG. 2, the plurality of cover lock portions 24 respectively project rearward from four corner positions of the rear end part of the outer wall portion 23. The wire cover 16 is made of synthetic resin and, as shown in FIG. 1, in the form of a cap. The wire cover 16 is locked by the respective cover lock portions 24 and held on the first housing 11 while covering the rear wall portion 22 from behind. The wire cover 16 is formed with a wire pull-out opening 28 open upward.

The lever 17 is made of synthetic resin and includes, as shown in FIG. 1, a pair of upper and lower arm portions 29 for covering the upper and lower surfaces of the outer wall portion 23. The arm portion 29 is formed with a shaft hole 31. The lever 17 is supported on the first housing 11 rotatably about the support shafts 26 fit into the shaft holes 31. The arm portion 29 is formed with a cam groove 32. The cam groove 32 communicates with the window portion 25 in the vertical direction. Cam followers 101 formed on the mating housing 100 shown in FIG. 6 enter the cam grooves 32 via the window portions 25. When the lever 17 is rotated, the cam followers 101 slide on groove surfaces of the cam grooves 32 and the connection of the connector 10 and the mating housing 100 proceeds.

As shown in FIG. 4, the rear wall portion 22 is formed with a plurality of insertion holes 33. Wires 120 are inserted through the insertion holes 33. The wires 120 extend rearward from the rear wall portion 22, are bent inside the wire cover 16 and are pulled out upward from the wire pull-out opening 28.

As shown in FIG. 5, a plurality of positioning projections 34 are formed to project on the front surface of the rear wall portion 22. The respective positioning projections 34 are in the form of pins and are arranged to correspond to four corner positions (except positions corresponding to four corners of the entire rear wall portion 22) in diagonal directions of each insertion hole 33 on the front surface of the rear wall portion 22.

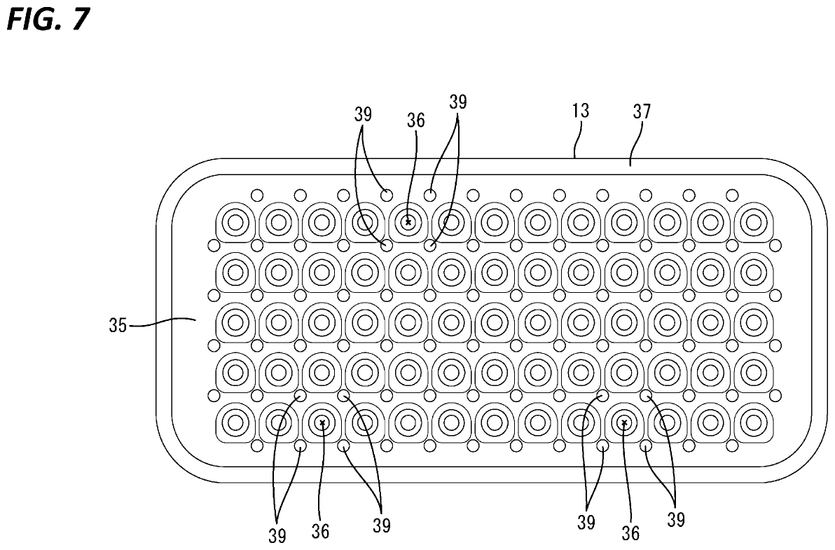

The sealing member 13 is made of rubber and includes a sealing body portion 35. The sealing body portion 35 is in the form of a rectangular plate with four rounded corners as shown in FIG. 7 and has a thickness in the front-rear direction as shown in FIGS. 3 and 4. The rear surface of the sealing body portion 35 is arranged to face the front surface of the rear wall portion 22. As shown in FIGS. 4 and 7, the sealing body portion 35 is formed with a plurality of sealing holes 36. Each sealing hole 36 communicates with each insertion hole 33 in the front-rear direction. A plurality of lips 37 are formed over the entire periphery on the outer peripheral surface of the sealing body portion 35. The respective lips 37 are arranged side by side in the front-rear direction on the outer peripheral surface of the sealing body portion 35.

As shown in FIG. 3, a plurality of positioning recesses 38 are formed in the rear surface of the sealing body portion 35. Each positioning recess 38 has a closed end at a position near a center in the front-rear direction of the sealing body portion 35 in a rear part of the sealing body portion 35. Further, the respective positioning recesses 38 are arranged to correspond to four corner positions (except positions corresponding to four corners of the entire sealing body portion 35) in diagonal directions of each sealing hole 36 on the rear surface of the sealing body portion 35.

A plurality of positioning recesses 39 are formed in the front surface of the sealing body portion 35. Each positioning recess 39 has a closed end at a position near the center in the front-rear direction of the sealing body portion 35 in a front part of the sealing body portion 35. Further, as shown in FIG. 7, the respective positioning recesses 39 are arranged to correspond to four corner positions (except positions corresponding to the four corners of the entire sealing body portion 35) in the diagonal directions of each sealing hole 36 on the front surface of the sealing body portion 35. As shown in FIG. 3, the positioning recesses 39 and the positioning recesses 38 are arranged side by side across the center in the front-rear direction of the sealing body portion 35.

The second housing 12 is made of synthetic resin and, as shown in FIGS. 3 and 4, accommodated inside the first housing 11. In the case of the first embodiment, the second housing 12 is a part serving as an inner housing and the first housing 11 is a part serving as an outer housing.

The pre-fitting member 14 includes a pre-fitting body portion 41. Th pre-fitting body portion 41 is in the form of a rectangular plate and has a thickness in the front-rear direction. The sealing member 13 is arranged to be sandwiched between the pre-fitting body portion 41 and the rear wall portion 22. The rear surface of the pre-fitting body portion 41 is arranged to face the front surface of the sealing member 13.

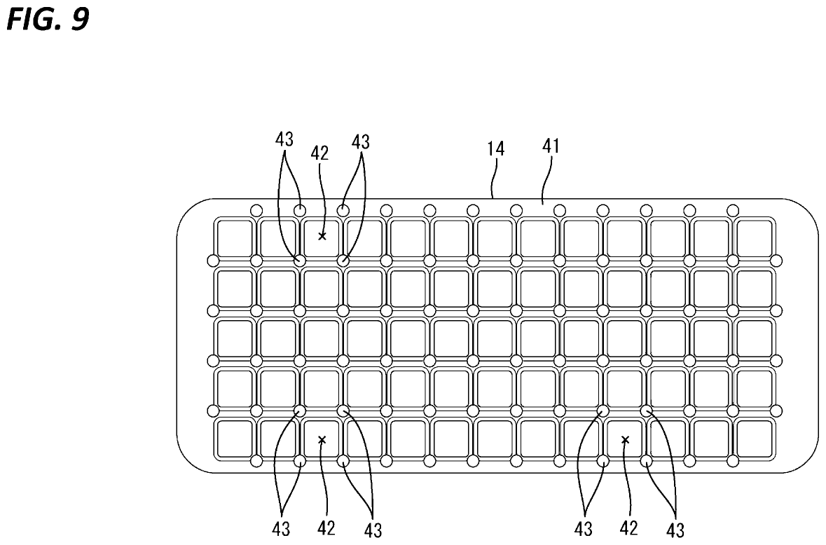

The pre-fitting body portion 41 is formed with a plurality of through holes 42. Each through hole 42 communicates with each sealing hole 36 of the sealing member 13 in the front-rear direction. A plurality of positioning projections 43 are formed to project rearward on the rear surface of the pre-fitting body portion 41. The respective positioning projection 43 are in the form of pins and are arranged to correspond to four corner positions (except positions corresponding to four corners of the entire pre-fitting body portion 41) in diagonal directions of each insertion hole 42 on the rear surface of the pre-fitting body portion 41 as shown in FIG. 9.

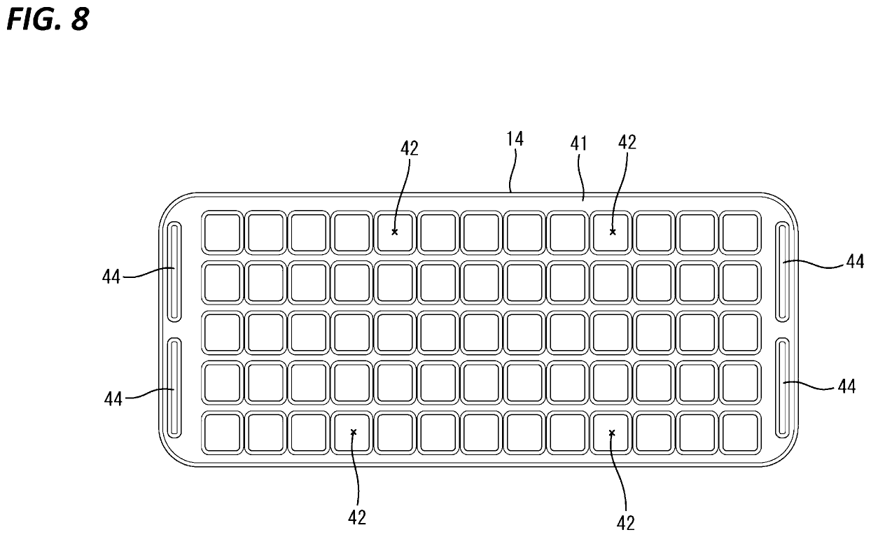

As shown in FIGS. 2 and 8, a pair of upper and lower alignment projections 44 are formed to project on each of both left and right end parts on the front surface of the pre-fitting body portion 41. The alignment projection 44 is in the form of a rectangular plate and has a thickness in the lateral direction.

The post-fitting member 15 includes a post-fitting body portion 45 as shown in FIG. 2. Th post-fitting body portion 45 is in the form of a housing and formed to be longer in the front-rear direction than the pre-fitting body portion 41. The post-fitting body portion 45 is formed with a plurality of cavities 46. As shown in FIG. 4, the terminal fitting 18 connected to an end part of the wire 120 is accommodated in each cavity 46. Each cavity 46 communicates with each through hole 42 in the front-rear direction. The post-fitting body portion 45 includes locking lances 47 for the respective cavities 46. The locking lance 47 projects forward from an inner side surface of the cavity 46. The terminal fitting 18 is locked by the locking lance 47 and primarily restricted from coming out from the post-fitting body portion 45.

The terminal fitting 18 is made of conductive metal and a female terminal is illustrated as such in the case of the first embodiment. A rear part of the terminal fitting 18 is crimped and connected to the wire 120. The terminal fitting 18 includes a tubular connecting portion 48 in a front part. A tab of an unillustrated mating male terminal is inserted into the connecting portion 48 for connection.

The post-fitting body portion 45 is formed with a retainer mounting hole 49. The retainer mounting hole 49 extends in the vertical direction and is, as shown in FIG. 2, open in a central part in the front-rear direction of the lower surface of the post-fitting body portion 45. The retainer 19 is inserted into the retainer mounting hole 49 from below. The retainer 19 is made of synthetic resin and in the form of a rectangular plate and has, as shown in FIGS. 3 and 4, a thickness in the front-rear direction. The terminal fitting 18 is locked by the retainer 19 and secondarily restricted from coming out from the post-fitting member 15.

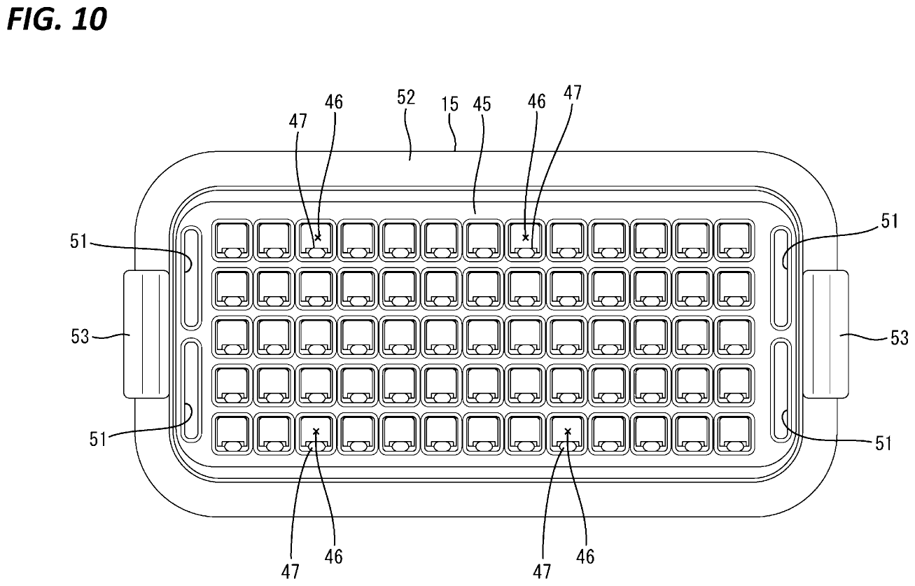

As shown in FIG. 10, a pair of upper and lower alignment recesses 51 are formed in each of both left and right end parts on the rear surface of the post-fitting body portion 45. Each alignment recess 51 is in the form of a slit long in the vertical direction.

The post-fitting member 15 includes a peripheral wall portion 52 projecting rearward from the outer periphery of the post-fitting body portion 45. The peripheral wall portion 52 is in the form of a rectangular tube with four rounded corners and formed over the entire outer periphery of the post-fitting member 15. As shown in FIGS. 3 and 4, the inner peripheral surface of the peripheral wall portion 52 is in close contact with the lips 37 of the sealing member 13. As shown in FIG. 10, a pair of lock portions 53 are formed to project outward on the rear end of the peripheral wall portion 52. The lock portion 53 is in the form of a claw long in the vertical direction and locked to the lock receiving portion 27 of the first housing 11 as shown in FIGS. 1 and 4.

The rubber ring 20 is made of rubber and, as shown in FIGS. 2, 3 and 4, mounted on a rear part of the outer peripheral surface of the post-fitting body portion 45. A step 54 is formed between the rear part of the outer peripheral surface of the post-fitting body portion 45 and the peripheral wall portion 52. The rear end of the rubber ring 20 is positioned in contact with the step 54. With the connector 10 connected to the mating housing 100, the rubber ring 20 is sandwiched between the mating housing 100 and the post-fitting body portion 45 in a liquid-tight manner.

The front holder 21 is made of synthetic resin and mounted on the post-fitting member 15 to cover the front surface of the post-fitting body portion 45. As shown in FIGS. 1 and 4, the front holder 21 is formed with a plurality of tab insertion holes 55. Each tab insertion hole 55 communicates with each cavity 46 in the front-rear direction. The connecting portion 48 is fit into a rear recess of the tab insertion hole 55 and butts against the front holder 21, whereby the terminal fitting 18 is restricted from coming out forward.

Next, an assembling procedure of the connector 10 of the first embodiment is described.

First, as shown in FIG. 2, the sealing member 13 is inserted into the first housing 11 from front. Each positioning projection 34 is fit and inserted into each positioning recess 38, whereby the sealing body portion 35 is positioned on the front surface side of the rear wall portion 22. Subsequently, the pre-fitting member 14 is inserted into the first housing 11 from front. Each positioning projection 43 is fit and inserted into each positioning recess 39, whereby the pre-fitting body portion 41 is positioned on the front surface side of the sealing body portion 35.

As shown in FIG. 6, a boundary between the front surface of the sealing body portion 35 and the rear surface of the pre-fitting body portion 41 can be visually confirmed through the window portion 25 from above or below. If the pre-fitting member 14 is not properly arranged on the front surface side of the sealing member 13, a gap is formed between the front surface of the sealing body portion 35 and the rear surface of the pre-fitting body portion 41. Thus, the pre-fitting body portion 41 is pushed toward the sealing body portion 35 to fill the gap. In this way, the pre-fitting member 14 is arranged without any gap on the front surface side of the sealing member 13 and each positioning projection 43 is properly inserted in each positioning recess 39.

When the pre-fitting member 14 is assembled, the sealing member 13 is not receiving a radially inward compression force from the peripheral wall portion 52 of the post-fitting member 15 and can maintain a state where the sealing member 13 is not compressively deformed radially inwardly. Thus, each positioning projection 43 can be satisfactorily fit into the corresponding positioning recess 39.

Subsequently, the post-fitting member 15 is inserted into the first housing 11. Note that the rubber ring 20 is mounted on the post-fitting member 15 in advance and the retainer 19 is held at a partial locking position.

Each alignment projection 44 is fit and inserted into each alignment recess 51 (see FIG. 3) and the post-fitting body portion 45 is positioned on the front surface side of the pre-fitting body portion 41. In this way, a state where the through holes 42 and the cavities 46 properly communicate in the front-rear direction is ensured (see FIG. 4). With the rear surface of the post-fitting body portion 45 held in contact with the front surface of the pre-fitting body portion 41, each lock portion 53 is locked to each lock receiving portion 27 and the post-fitting member 15 is held in the first housing 11 in a state where the escape thereof is restricted (see FIGS. 1 and 4). Further, the pre-fitting member 14 and the sealing member 13 are also held between the post-fitting member 15 and the first housing 11 with the escape thereof restricted.

With the post-fitting member 15 held in the first housing 11, the inner peripheral surface of the peripheral wall portion 51 is in close contact with the lips 37 of the sealing member 13. The sealing member 13 is pressed radially inwardly by the peripheral wall portion 52. Thus, a radially inward compressive force is applied to the sealing member 13. However, since each positioning projection 43 is already inserted in each positioning recess 39, there is no such trouble that each positioning projection 43 cannot be inserted into each positioning recess 39 due to the application of the compressive force to the sealing member 13. Further, the sealing member 13 is also not largely compressively deformed radially inwardly.

Subsequently, each terminal fitting 18 is inserted into the cavity 46 from the insertion hole 33 through the sealing hole 36 and the through hole 42. The wire 120 connected to the terminal fitting 18 is inserted in the insertion hole 33, the sealing hole 36 and the through hole 42 (see FIG. 4). The outer peripheral surface of the wire 120 is held in close contact with the inner peripheral surface of the sealing hole 36. In this way, the intrusion of water and oil into the cavity 46 is hindered. Thereafter, the retainer 19 is pushed to a full locking position and the terminal fittings 18 are locked with the escape thereof from the cavities 46 restricted.

In the case of the first embodiment, after the pre-fitting member 14 is arranged on the front surface side of the sealing member 13 and each positioning projection 43 is inserted into each positioning recess 39, the post-fitting member 15 is assembled and the peripheral wall portion 52 is held in close contact with the lips 37 of the sealing member 13. When the sealing member 13 is pressed by the peripheral wall portion 52 and a radially inward compressive force is applied to the sealing member 13, each positioning projection 43 is already fit in each positioning recess 39. Thus, it is possible to avoid such a trouble that each positioning projection 43 cannot be inserted into each positioning recess 39. In this way, the positioning accuracy of the sealing member 13 can be improved. As a result, the sealability of the sealing member 13 can be satisfactorily maintained.

Further, since the post-fitting body portion 45 is arranged in front of the pre-fitting body portion 41, forward escape of the pre-fitting member 14 is hindered by the post-fitting body portion 45. Further, since the post-fitting body portion 45 is structured to include the plurality of cavities 46, the post-fitting member 15 can be formed without largely changing an existing housing. In contrast, since the pre-fitting body portion 41 has a plate-like structure having a thickness in the front-rear direction, the pre-fitting member 14 can be formed compact.

Furthermore, since the boundary between the front surface of the sealing body portion 35 and the rear surface of the pre-fitting body portion 41 can be visually confirmed through the window portion 25 of the outer wall portion 23 as shown in FIG. 6 before the post-fitting member 15 is assembled, it is possible to confirm whether or not a relative positional relationship of the sealing member 13 and the pre-fitting member 14 is proper. As a result, it is possible to confirm whether or not each positioning projection 43 is properly inserted in each positioning recess 39. Moreover, since the window portions 25 also have a function of receiving the cam followers 101, the configuration of the outer wall portion 23 does not become complicated due to the presence of the window portions 25. Further, the pre-fitting member 14 and the post-fitting member 15 can be positioned with respect to each other by inserting each alignment projection 44 into each alignment recess 51.

### Second Embodiment

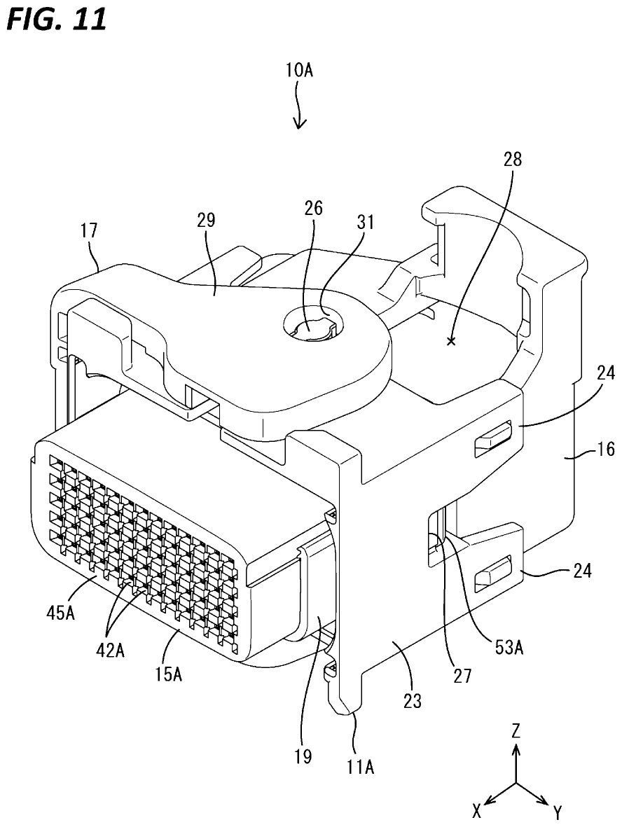

Next, a second embodiment is described with reference to FIGS. 11 to 16. The second embodiment largely differs from the first embodiment in the structure of a second housing 12A and differs from the first embodiment in that a connector 10A includes no front holder 21. Other points are similar to the first embodiment. In the second embodiment, structures identical to or corresponding to those of the first embodiment are denoted by the same reference signs and parts different from the first embodiment are mainly described.

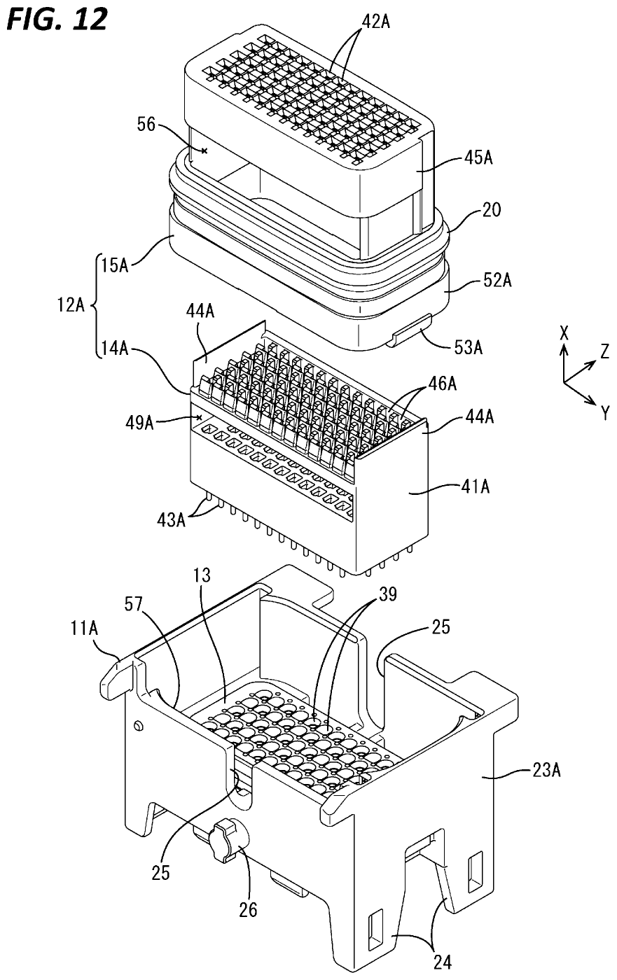

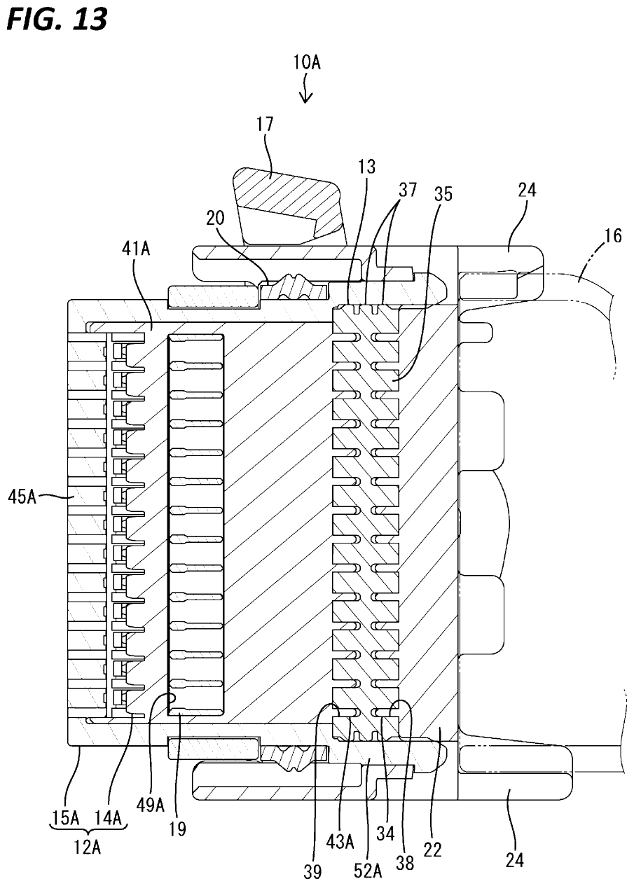

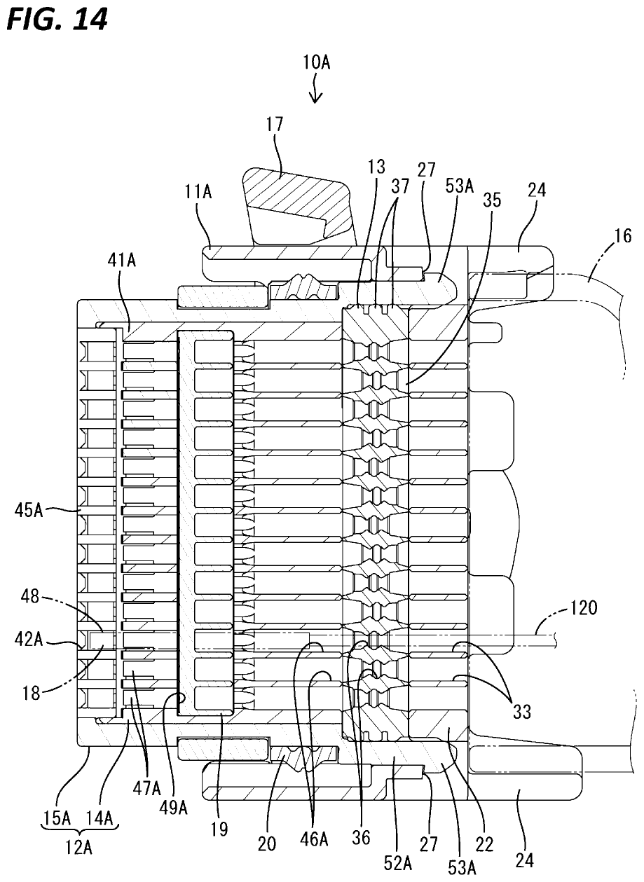

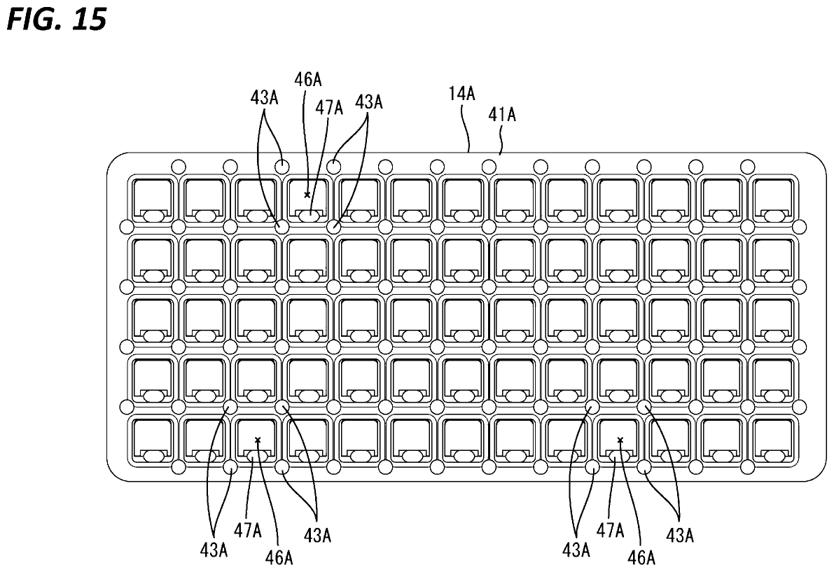

As shown in FIGS. 12 and 13, a pre-fitting member 14A includes a housing-like pre-fitting body portion 41A. The pre-fitting body portion 41A is formed with a plurality of cavities 46A. A locking lance 47A is formed to project on an inner side surface of each cavity 46A as shown in FIGS. 14 and 15. A terminal fitting 18 is inserted into the cavity 46A and locked by the locking lance 47A, thereby being primarily restricted from coming out from the pre-fitting member 14A.

The pre-fitting body portion 41A is formed with a retainer mounting hole 49A. The retainer mounting hole 49A extends in the vertical direction and is, as shown in FIG. 12, open in a central part in the front-rear direction of the lower surface of the pre-fitting body portion 41A. As shown in FIG. 13, the rear surface of the pre-fitting body portion 41A is arranged to face the front surface of a sealing body portion 35. A plurality of positioning projections 43A are formed to project at four corner positions (except positions corresponding to four corners of the entire pre-fitting body portion 41A) in diagonal directions of each cavity 46A on the rear surface of the pre-fitting body portion 41A. A pair of left and right plate-like alignment projections 44A are formed to project on the front surface of the pre-fitting body portion 41A as shown in FIG. 12.

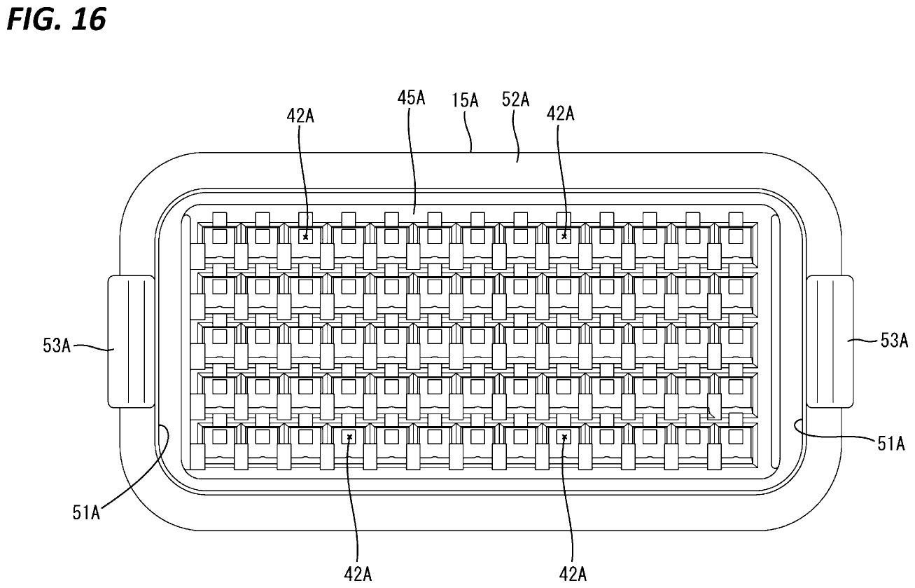

The post-fitting member 15A includes a post-fitting body portion 45A in the form of a rectangular plate and a peripheral wall portion 52A projecting rearward from the outer periphery of the post-fitting body portion 45A. The post-fitting body portion 45A is located in front of the locking lances 47A to protect the locking lances 47 from external matters. The rear surface of the post-fitting body portion 45A is arranged to face the front surface of the pre-fitting body portion 41A as shown in FIG. 14. A pair of left and right alignment recesses 51A are formed in the rear surface of the post-fitting body portion 45A as shown in FIG. 16. The post-fitting body portion 45A is formed with a plurality of through holes 42A. Each through hole 42A communicates with each cavity 46A in the front-rear direction.

The peripheral wall portion 52A is in the form of a rectangular tube with four rounded corners. As shown in FIG. 12, a retainer insertion hole 56 is formed to penetrate through the lower wall of the peripheral wall portion 52A at a position near the post-fitting body portion 45A. An outer wall portion 23A of a first housing 11A is formed with a cut portion 57 open on the front end of a lower wall. The cut portion 57, the retainer insertion hole 56 and the retainer mounting hole 49A communicate in the vertical direction.

A rubber ring 20 is mounted behind the retainer insertion hole 56 on the outer peripheral surface of the peripheral wall portion 52A. Further, a pair of left and right lock portions 53A are formed to project outward on the rear end of the peripheral wall portion 52A.

In assembling the connector 10A, the sealing body portion 35 is arranged on a front surface side of a rear wall portion 22. By fitting and inserting each positioning projection 34 into each positioning recess 38, the first housing 11A is positioned with respect to the sealing member 13. Subsequently, the pre-fitting body portion 41A is arranged on a front surface side of the sealing body portion 35. By fitting and inserting each positioning projection 43A into each positioning recess 39, the pre-fitting member 14A is positioned with respect to the sealing member 13. Subsequently, the post-fitting body portion 45A is arranged on a front surface side of the pre-fitting body portion 41A. By fitting and inserting each alignment projection 44A into each alignment recess 51A, the post-fitting member 15A is positioned with respect to the pre-fitting member 14A. Further, by locking each lock portion 53A to each lock receiving portion 27, the post-fitting member 15A is held in the first housing 11A (see FIG. 14). The pre-fitting member 14A and the sealing member 13 are held between the post-fitting member 15A and the first housing 11A. The inner peripheral surface of the peripheral wall portion 52A is held in close contact with lips 37 of the sealing member 13 and a radially inward compressive force is applied to the sealing member 13.

Subsequently, each terminal fitting 18 is inserted into the cavity 46A. A connecting portion 48 of the terminal fitting 18 is fit into a rear recess of the through hole 42A and butts against the post-fitting body portion 45A, whereby forward escape of the terminal fitting 18 is restricted (see FIG. 14). Further, the retainer 19 is pushed to a full locking position with respect to the retainer mounting hole 49A and the terminal fittings 18 are locked with the escape thereof restricted. Note that an operation of moving the retainer 19 can be performed through the cut portion 57 and the retainer insertion hole 56.

According to the second embodiment, as in the first embodiment, after the pre-fitting member 14A is arranged on the front surface side of the sealing member 13 and each positioning projection 43A is inserted into each positioning recess 39, the post-fitting member 15A is assembled and the peripheral wall portion 52A can be held in close contact with the lips 37 of the sealing member 13. In this way, the positioning accuracy of the sealing member 13 can be improved. Further, since the post-fitting body portion 45A also has a function as a front holder in the case of the second embodiment, a dedicated front holder can be omitted.

### Other Embodiments of Present Disclosure

The embodiments disclosed this time should be considered illustrative in all aspects, rather than restrictive.

In the case of the first and second embodiments, the second housing composed of the pre-fitting member and the post-fitting member is structured to be inserted into the first housing. However, the second housing may not be inserted into the first housing and, for example, the first and second housings may be arranged side by side in the front-rear direction. That is, the first housing is not limited to a part serving as an outer housing and the second housing is not limited to a part serving as an inner housing.

In the case of the first and second embodiments, the post-fitting member includes the post-fitting body portion and the peripheral wall portion. However, the post-fitting member may not include the post-fitting body portion and may be, for example, composed only of the peripheral wall portion.

In the case of the first and second embodiments, the pre-fitting member is formed with the alignment projections and the post-fitting member is formed with the alignment recesses. However, the post-fitting member may be formed with the alignment projections and the pre-fitting member may be formed with the alignment recesses.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a first housing;
a second housing; and
a sealing member to be arranged between the first housing and the second housing,
wherein:
the sealing member includes a sealing body portion, a sealing hole penetrating through the sealing body portion in a front-rear direction and a positioning recess formed in a front surface of the sealing body portion,
the second housing includes a pre-fitting member and a post-fitting member separate from the pre-fitting member,
the pre-fitting member includes a pre-fitting body portion to be arranged in front of the sealing body portion and a positioning projection projecting from a rear surface of the pre-fitting body portion and to be fit into the positioning recess, and
the post-fitting member includes a peripheral wall portion to be held in contact with an outer peripheral surface of the sealing member.

2. The connector of claim 1, wherein the post-fitting member includes a post-fitting body portion to be arranged in front of the pre-fitting body portion and the peripheral wall portion projects rearward from the post-fitting body portion.

3. The connector of claim 2, wherein:
the pre-fitting body portion is in the form of a plate having a thickness in the front-rear direction, and
the post-fitting body portion includes a cavity for accommodating a terminal fitting and a locking lance projecting inside the cavity to lock the terminal fitting and is formed longer in the front-rear direction than the pre-fitting body portion.

4. The connector of claim 2, wherein:
the post-fitting body portion is in the form of a plate having a thickness in the front-rear direction, and
the pre-fitting body portion includes a cavity for accommodating a terminal fitting and a locking lance projecting inside the cavity to lock the terminal fitting and is formed longer in the front-rear direction than the post-fitting body portion.

5. The connector of claim 1, wherein:
the second housing includes an outer wall portion for covering the first housing, and
the outer wall portion is formed with a window portion for enabling a boundary between a front surface of the sealing body portion and a rear surface of the pre-fitting body portion to be visually confirmed.

6. The connector of claim 5, wherein:
a lever is rotatably supported on the outer wall portion, the lever is formed with a cam groove and the cam groove is engaged with a cam follower of a mating housing, and
the window portion is open on a front end of the outer wall portion and in the form of a groove for receiving the cam follower.

7. The connector of claim 1, wherein either one of the pre-fitting member and the post-fitting member is formed with an alignment projection projecting toward the other, and the other is formed with an alignment recess to be fit to the alignment projection.
